(19) United States
(12) Patent Application Publication
(10) Pub. No.: US 2023/0316799 A1
(43) Pub. Date: Oct. 5, 2023

(54) INPUT DEVICE

(71) Applicant: NIDEC SANKYO CORPORATION, Nagano (JP)

(72) Inventors: Shinya MIYAZAWA, NAGANO (JP); Junro TAKEUCHI, NAGANO (JP); Masaya FUJIMOTO, NAGANO (JP); Yosuke OGUCHI, NAGANO (JP)

(73) Assignee: NIDEC SANKYO CORPORATION, Nagano (JP)

(21) Appl. No.: 18/191,852

(22) Filed: Mar. 28, 2023

(30) Foreign Application Priority Data
Mar. 29, 2022 (JP) 2022-052772

(51) Int. Cl. G06V 40/13; H05K 1/18; H05K 1/02; H05K 5/00; H05K 5/02

(52) U.S. Cl. CPC G06V 40/13; H05K 1/189; H05K 1/0275; H05K 5/003; H05K 5/0018; H05K 5/0247; H05K 2201/10053

(57) ABSTRACT

An input device for inputting information by using a finger tip of a user includes a finger tip detection mechanism which detects a position of the finger tip of the user in an input part to which information is inputted, a circuit board on which the finger tip detection mechanism is mounted, a flexible printed board which covers at least a part of the circuit board, a main body part to which the circuit board is attached, and a detachment detection mechanism which detects detachment of the circuit board from the main body part. The flexible printed board is formed with a tamper detection pattern for detecting at least its own disconnection, and the detachment detection mechanism includes a contact type detection switch, and the detection switch is disposed between a portion of the circuit board covered by the flexible printed board and the main body part.

### CROSS REFERENCE TO RELATED APPLICATION

The present invention claims priority under 35 U.S.C. § 119 to Japanese Application No. 2022-052772 filed Mar. 29, 2022, the entire content of which is incorporated herein by reference.

### TECHNICAL FIELD

At least an embodiment of the present invention may relate to an input device structured to input information by using a finger tip of a user.

### BACKGROUND

Conventionally, an input device structured to input information by using a finger tip of a user has been known (see, for example, WO 2022/018972 (Al) (Patent Literature 1). The input device described in Patent Literature 1 is, for example, used in an authentication device at the time of settlement performed by using, for example, a credit card. This input device includes an aerial image display device which displays an aerial image in a three-dimensional space and an optical type detection mechanism for detecting a position of a finger tip of a user in an aerial image display region which is a region where an aerial image is displayed. The detection mechanism is mounted on a circuit board. The aerial image display region is an input part for inputting information.

In the input device described in Patent Literature 1, a personal identification number is inputted in the input part. In this case, a user inputs his/her personal identification number by utilizing a keypad which is displayed as an aerial image in an aerial image display region. Specifically, a user successively moves his/her finger tip to positions of predetermined keys (figures) in a keypad which is displayed in an aerial image display region and inputs his/her personal identification number. In the input device, the personal identification number which is inputted from the input part is identified based on detection results of the detection mechanism.

In the input device described in Patent Literature 1, a personal identification number is identified based on detection results of the detection mechanism and, in a circuit board on which the detection mechanism is mounted, data for identifying a personal identification number which are data required to ensure safety are transmitted and processed. Therefore, in the input device described in Patent Literature 1, it is required that illegal acquisition of data from the circuit board on which the detection mechanism is mounted is effectively prevented.

### SUMMARY

At least an embodiment of the present invention may advantageously provide an input device for inputting information such as a personal identification number by using a finger tip of a user, the input device being capable of effectively preventing illegal acquisition of data from a circuit board on which a finger tip detection mechanism for detecting a position of a finger tip of a user is mounted.

According to at least an embodiment of the present invention, there may be provided an input device in which information is inputted by using a finger tip of a user, the input device including a finger tip detection mechanism which detects a position of the finger tip of the user in an input part to which information is inputted, a circuit board on which the finger tip detection mechanism is mounted, a flexible printed board which covers at least a part of the circuit board, a main body part to which the circuit board is attached, and a detachment detection mechanism which detects detachment of the circuit board from the main body part. The flexible printed board is formed with a tamper detection pattern for detecting at least own disconnection, the detachment detection mechanism includes a contact type detection switch, and the contact type detection switch is disposed between a portion of the circuit board which is covered by the flexible printed board and the main body part.

The input device in accordance with at least an embodiment of the present invention includes a flexible printed board which covers at least a part of a circuit board and is formed with a tamper detection pattern. Therefore, according to this embodiment, a portion of the circuit board which is required to ensure safety (in other words, a portion of the circuit board in which data required to ensure safety are transmitted, or a portion of the circuit board where processing of data required to ensure safety is performed) is covered by the flexible printed board. Accordingly, when a criminal has illegally accessed a portion of a circuit board which is required to ensure safety for illegally acquiring data from the circuit board, the tamper detection pattern can be disconnected and, when the disconnection of the tamper detection pattern is detected, a predetermined abnormality processing can be executed.

Further, the input device in this embodiment includes a detachment detection mechanism for detecting detachment of the circuit board from the main body part and thus, when a criminal has detached the circuit board from the main body part for illegally acquiring data from the circuit board, a predetermined abnormality processing can be executed based on a detection result of the detachment detection mechanism. In addition, in the input device in this embodiment, a contact type detection switch provided in the detachment detection mechanism is disposed between a portion of the circuit board which is covered by the flexible printed board and the main body part. Therefore, the portion of the circuit board which is required to ensure safety is covered by the flexible printed board and thus, the main body part can be disposed in the vicinity of the portion of the circuit board which is required to ensure safety. Accordingly, in this embodiment, it is difficult for a criminal to access the portion of the circuit board which is required to ensure safety.

As described above, in this embodiment, a predetermined abnormality processing is executed when a disconnection of the tamper detection pattern is detected, and a predetermined abnormality processing is executed based on a detection result of the detachment detection mechanism and, in addition, it is difficult for a criminal to access the portion of the circuit board which is required to ensure safety. Therefore, according to this embodiment, illegal acquisition of data from the circuit board can be prevented effectively.

In this embodiment, for example, the main body part includes a control module having a control board which is electrically connected with the circuit board, encrypted data are transmitted to the control board from the circuit board, the control module includes a housing in which the control board is accommodated, and the contact type detection switch is disposed between the portion of the circuit board which is covered by the flexible printed board and the housing.

According to this structure, the portion of the circuit board which is required to ensure safety is covered by the flexible printed board and thus, a housing of the control module can be disposed in the vicinity of the portion of the circuit board which is required to ensure safety. Therefore, when a criminal has illegally accessed the portion of the circuit board which is required to ensure safety, the control module may be easily damaged. Accordingly, when a predetermined abnormality processing is executed when damage of the control module is detected, illegal acquisition of data from the circuit board can be further effectively prevented.

In this embodiment, for example, the flexible printed board covers the part of the circuit board from both sides in a thickness direction of the circuit board, the main body part is disposed on one side with respect to the circuit board in the thickness direction of the circuit board, and an entire portion of the circuit board which is covered by the flexible printed board is overlapped with the housing in the thickness direction of the circuit board.

According to this structure, the entire portion of the circuit board which is covered by the flexible printed board is overlapped with the housing in the thickness direction of the circuit board. Therefore, the portion of the circuit board which is required to ensure safety is covered by the flexible printed board and thus, it is difficult for a criminal to access the portion of the circuit board which is required to ensure safety. Further, when a criminal has illegally accessed the portion of the circuit board which is required to ensure safety, the control module is further easily damaged and thus, when damage of the control module is detected, a predetermined abnormality processing is executed and thereby, illegal acquisition of data from the circuit board can be further effectively prevented.

In this embodiment, for example, the contact type detection switch is mounted on the flexible printed board. According to this structure, another board for mounting the contact type detection switch is not required. Therefore, a structure of the input device can be simplified.

In this embodiment, for example, the input device includes a flat plate member in a flat plate shape which is disposed between the circuit board and the main body part in a thickness direction of the circuit board, and a part of the flexible printed board is stuck on the flat plate member. In this case, the flat plate member is disposed between the circuit board and the main body part and thus, it is further difficult for a criminal to access a portion of the circuit board which is required to ensure safety.

In this embodiment, for example, in response to one side in a thickness direction of the circuit board being referred to as a first direction side, and an opposite side to the first direction side being referred to as a second direction side, the flexible printed board is provided with a first board part which covers the part of the circuit board from the first direction side, a second board part which covers the part of the circuit board from the second direction side, and a connecting board part which connects the first board part with the second board part, and the main body part is disposed on the first direction side of the flexible printed board.

In this embodiment, for example, the input device includes a contact type second detection switch which detects separation of the first board part from the second board part. According to this structure, if a criminal has performed some act for illegally acquiring data from the circuit board and, when the first board part and the second board part are separated from each other, a predetermined abnormality processing can be executed based on a detection result of the second detection switch. Therefore, illegal acquisition of data from the circuit board can be further effectively prevented.

In this embodiment, for example, the flexible printed board is provided with a third board part which is connected with the first board part, a face on the first direction side of the first board part and a face on the second direction side of the third board part are faced each other, the contact type second detection switch is mounted on a face on the first direction side of the second board part, and the contact type detection switch is mounted on a face on the first direction side of the third board part. In this case, in the flexible printed board in a developed state, the detection switch and the second detection switch are mounted on the same face of the flexible printed board. Therefore, mounting work of the detection switch and the second detection switch on the flexible printed board can be performed easily.

In this embodiment, for example, the main body part includes a display mechanism having a display surface which displays an image, and an aerial image forming mechanism which forms an image as an aerial image by projecting the image displayed on the display surface in a space, and the input part is an aerial image display region which is a region where the aerial image is displayed.

### Effects of the Invention

As described above, in accordance with an embodiment of the present invention, in an input device for inputting information such as a personal identification number by using a finger tip of a user, the input device is capable of effectively preventing illegal acquisition of data from a circuit board on which a finger tip detection mechanism for detecting a position of the finger tip of the user is mounted.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an input device in accordance with an embodiment of the present invention.

FIG. 2 is a perspective view showing a state that a housing cover is detached from the input device shown in FIG. 1.

FIG. 3 is a perspective view showing a state that a main body part and an input module shown in FIG. 2 are separated from each other.

FIG. 4 is a perspective view showing the input module in FIG. 3 which is viewed in a different direction.

FIG. 5 is an explanatory perspective view showing a structure of the input module shown in FIG. 4.

FIG. 6 is an explanatory schematic view showing a structure of the input device in FIG. 1.

FIG. 7 is an explanatory schematic view showing a structure of an aerial image display mechanism which is used in the input device shown in FIG. 1.

FIG. 8 is a view showing an example of an aerial image which is displayed in an aerial image display region shown in FIG. 1.

FIGS. 9A and 9B are perspective views showing a circuit board, a flexible printed board and the like shown in FIG. 5.

FIGS. 10A and 10B are enlarged views showing a structure of a detachment detection mechanism shown in FIG. 4.

FIG. 11 is an explanatory block diagram showing a configuration of a control board in FIG. 3.

### DETAILED DESCRIPTION

An embodiment of the present invention will be described below with reference to the accompanying drawings.

(Entire Structure of Input Device)

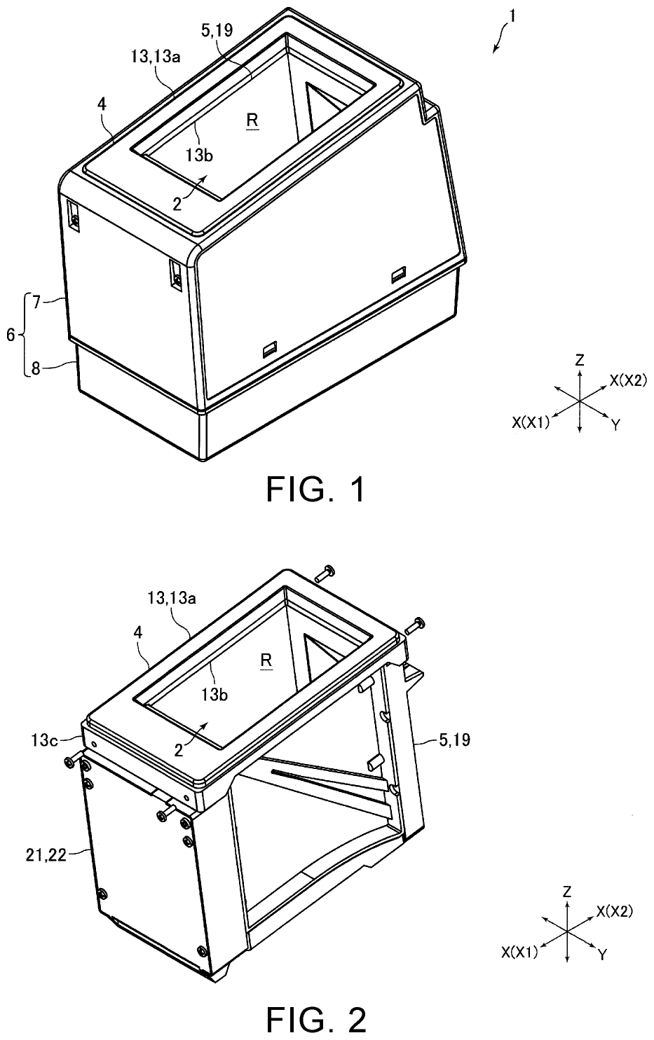

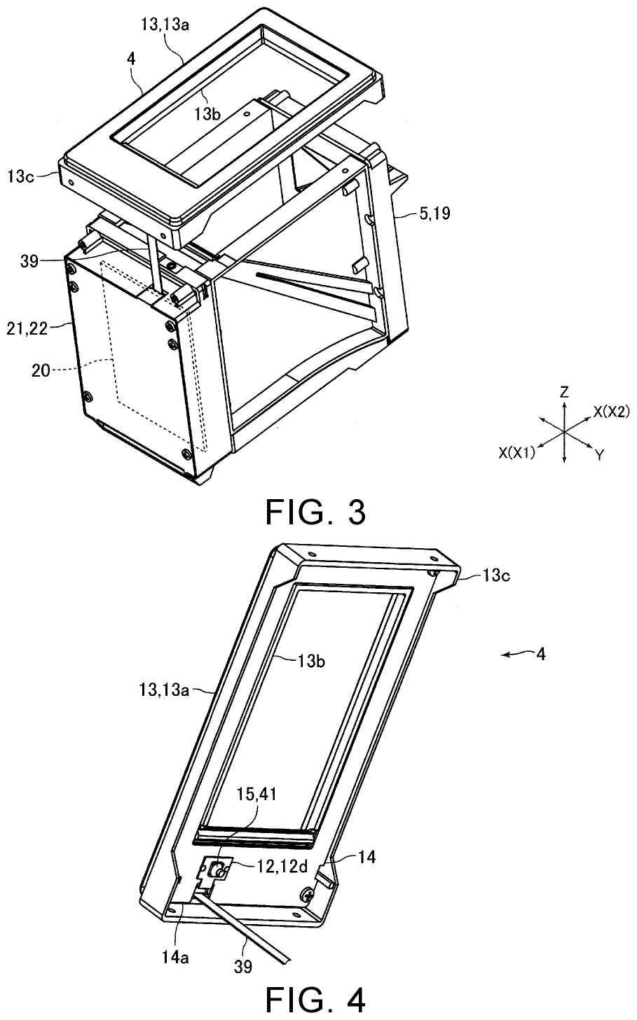

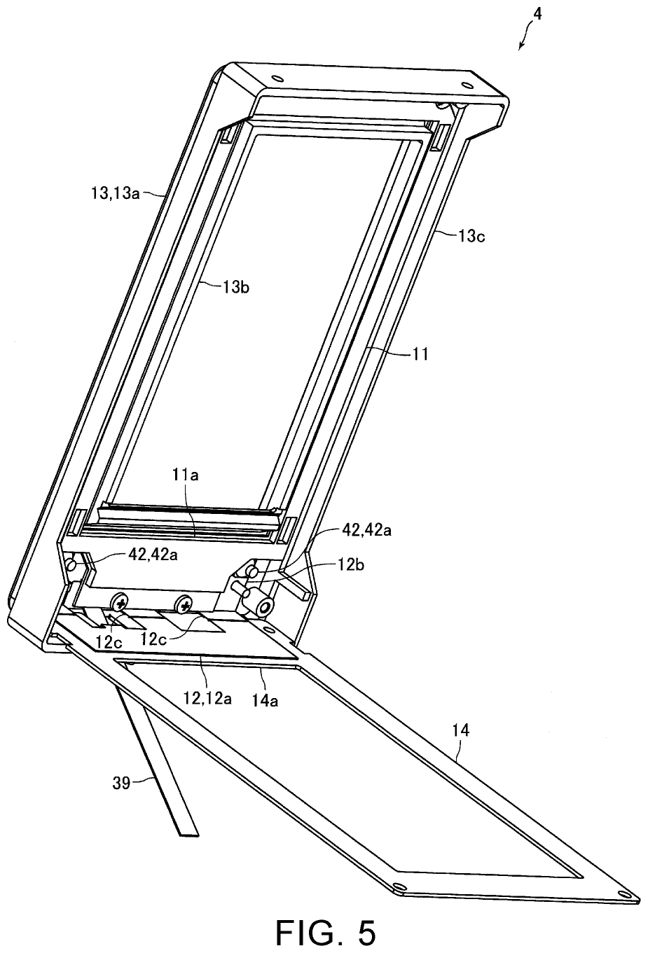

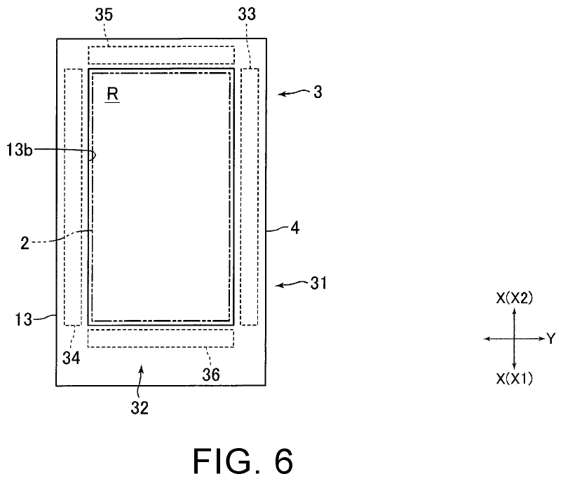

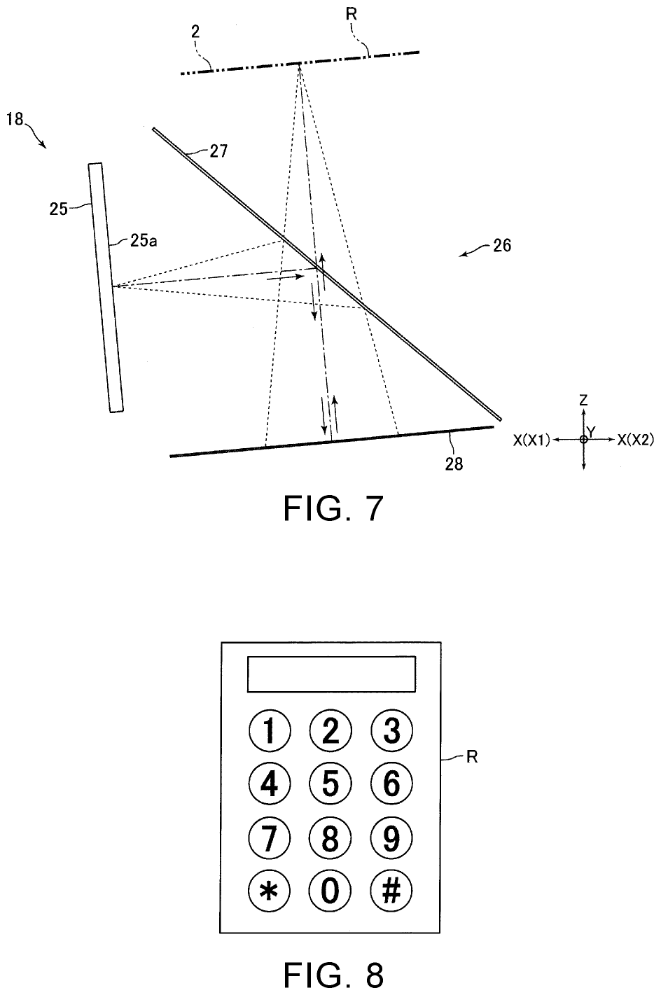

FIG. 1 is a perspective view showing an input device 1 in accordance with an embodiment of the present invention. FIG. 2 is a perspective view showing a state that a housing cover 6 is detached from the input device 1 shown in FIG. 1. FIG. 3 is a perspective view showing a state that a main body part 5 and an input module 4 shown in FIG. 2 are separated from each other. FIG. 4 is a perspective view showing the input module 4 in FIG. 3 which is viewed in a different direction. FIG. 5 is an explanatory perspective view showing a structure of the input module 4 shown in FIG. 4. FIG. 6 is an explanatory schematic view showing a structure of the input device 1 in FIG. 1. FIG. 7 is an explanatory schematic view showing a structure of an aerial image display mechanism 18 which is used in the input device 1 shown in FIG. 1. FIG. 8 is a view showing one example of an aerial image which is displayed in an aerial image display region “R” shown in FIG. 1.

An input device 1 in this embodiment is a device which is structured to input information by using a finger tip of a user. The input device 1 is, for example, used as an authentication device at the time of settlement performed with a credit card or the like. In the input device 1 in this embodiment, a personal identification number is inputted. The input device 1 is, for example, installed and used so that the “Z” direction in FIG. 1 and the like and an upper and lower direction (vertical direction) are coincided with each other. In the following descriptions, the “Z” direction in FIG. 1 and the like is set in an upper and lower direction, the “Y” direction in FIG. 1 and the like which is perpendicular to the upper and lower direction is set in a right and left direction, and the “X” direction in FIG. 1 and the like which is perpendicular to the upper and lower direction and the right and left direction is set in a front and rear direction. Further, the “X1” direction side in FIG. 1 and the like which is one side in the front and rear direction is referred to as a “front” side, and the “X2” direction side in FIG. 1 and the like on the opposite side to the “X1” side is referred to as a “rear” side.

In this embodiment, a user who stands in front of the input device 1 performs a predetermined operation on the input device 1 from an upper side. The input device 1 includes an input module 4 having a finger tip detection mechanism 3 (see FIG. 6) structured to detect a position of a finger tip of a user in an input part 2 to which information is inputted, a main body part 5 to which the input module 4 is attached, and a housing cover 6 which covers a part of the input module 4 and the main body part 5. As shown in FIG. 1, the housing cover 6 is structured of an upper side housing cover 7 which structures an upper side portion of the housing cover 6, and a lower side housing cover 8 which structures a lower side portion of the housing cover 6.

The input module 4 is fixed to an upper end part of the main body part 5. The input module 4 includes, in addition to the finger tip detection mechanism 3, a circuit board 11 (see FIG. 5), on which the finger tip detection mechanism 3 is mounted, a flexible printed board 12 (hereinafter, referred to as an “FPC12”) which covers at least a part of the circuit board 11, a cover member 13 to which the circuit board 11 is fixed, and a flat plate member 14 in a flat plate shape which is fixed to the cover member 13 so as to cover the circuit board 11 from a lower side.

The cover member 13 is structured of a base part 13a which is formed in a rectangular frame shape, an inner side tube part 13b in a rectangular tube shape which is protruded from an inner peripheral end of the base part 13a toward a lower side, and an outer side tube part 13c in a rectangular tube shape which is protruded from an outer peripheral end of the base part 13a toward a lower side. The cover member 13 is formed with a rectangular through hole which penetrates through in the upper and lower direction. The cover member 13 is disposed so that a long side direction of the base part 13a which is formed in a rectangular frame shape is coincided with the front and rear direction. The circuit board 11 is a rigid board such as a glass epoxy substrate. The flat plate member 14 is a metal plate made of metal. The circuit board 11 and the flat plate member 14 are formed in a flat plate shape. Further, the circuit board 11 and the flat plate member 14 are formed in a rectangular frame shape. The circuit board 11 and the flat plate member 14 are disposed between the inner side tube part 13b and the outer side tube part 13c.

The cover member 13 is fixed to an upper end part of the main body part 5. In other words, the circuit board 11 and the flat plate member 14 which are fixed to the cover member 13 are attached to the main body part 5 through the cover member 13. Further, the input module 4 includes a detachment detection mechanism 15 structured to detect that the input module 4 has been detached from the main body part 5. In other words, the input module 4 includes the detachment detection mechanism 15 structured to detect detachment of the circuit board 11 from the main body part 5. A specific structure of the input module 4 will be described below.

The main body part 5 includes an aerial image display mechanism 18 (see FIG. 7) which displays an aerial image in a three-dimensional space, and a housing 19 in which the aerial image display mechanism 18 is accommodated. Further, the main body part 5 includes a control module 21 having a control board 20 (see FIG. 3) which is electrically connected with the circuit board 11. The housing 19 is formed in a box shape in a rectangular prism shape whose upper face side and front face side are opened. The control board 20 is a rigid board such as a glass epoxy substrate and is, for example, formed in a rectangular flat plate shape. The control module 21 includes a housing 22 in which the control board 20 is accommodated. The control module 21 is fixed to a front end part of the housing 19 so as to close an opening on the front face side of the housing 19.

As shown in FIG. 7, the aerial image display mechanism 18 includes a display mechanism 25 having a display surface 25a on which an image is displayed, and an aerial image forming mechanism 26 which projects an image displayed on the display surface 25a to a space and makes an image as an aerial image. The aerial image forming mechanism 26 includes a beam splitter 27 and a retroreflective material 28. The display mechanism 25 is, for example, a liquid crystal display or an organic EL display, and the display surface 25a is a screen of the display. The display mechanism 25 is fixed to a rear face of the housing 22 of the control module 21. The display surface 25a is directed to a rear side. The display mechanism 25 is electrically connected with the control board 20.

The beam splitter 27 is disposed on a rear side with respect to the display mechanism 25. The beam splitter 27 reflects a part of light emitted from the display surface 25a. The retroreflective material 28 is disposed on a lower side with respect to the beam splitter 27. The light reflected by the beam splitter 27 is incident on the retroreflective material 28. The retroreflective material 28 reflects the incident light toward the beam splitter 27 in the same direction as the incident direction. The light reflected by the retroreflective material 28 is transmitted through the beam splitter 27. An aerial image is formed by the light transmitted through the beam splitter 27.

In this embodiment, an inner peripheral side with respect to the inner side tube part 13b of the cover member 13 is an aerial image display region “R” which is an area where an aerial image is displayed, and the aerial image display region “R” is surrounded by the inner side tube part 13b (see FIG. 6). Further, in this embodiment, the aerial image display region “R” is the input part 2 in which a user inputs a personal identification number by using his/her finger tip. In other words, an inner peripheral side with respect to the inner side tube part 13b of the cover member 13 is formed to be the input part 2.

When a personal identification number is to be inputted to the input part 2, the display mechanism 25 displays an image of a keypad for inputting a personal identification number on the display surface 25a, and the aerial image forming mechanism 26 displays the image of the keypad which is displayed on the display surface 25a in the aerial image display region “R” as an aerial image (see FIG. 8). A user inputs his/her personal identification number by utilizing the keypad displayed in the aerial image display region “R”. Specifically, a user inputs his/her personal identification number by successively moving his/her finger tip to positions of predetermined keys (figures) in the keypad displayed in the aerial image display region “R”. In other words, a user inputs his/her personal identification number by successively moving his/her finger tip in the input part 2.

(Structure of Input Module)

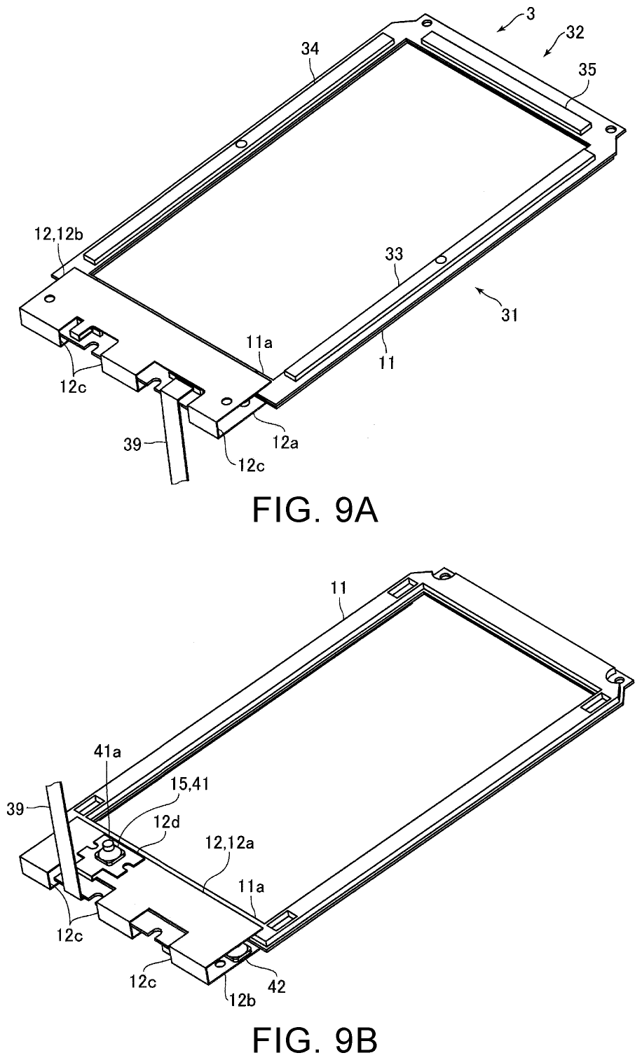

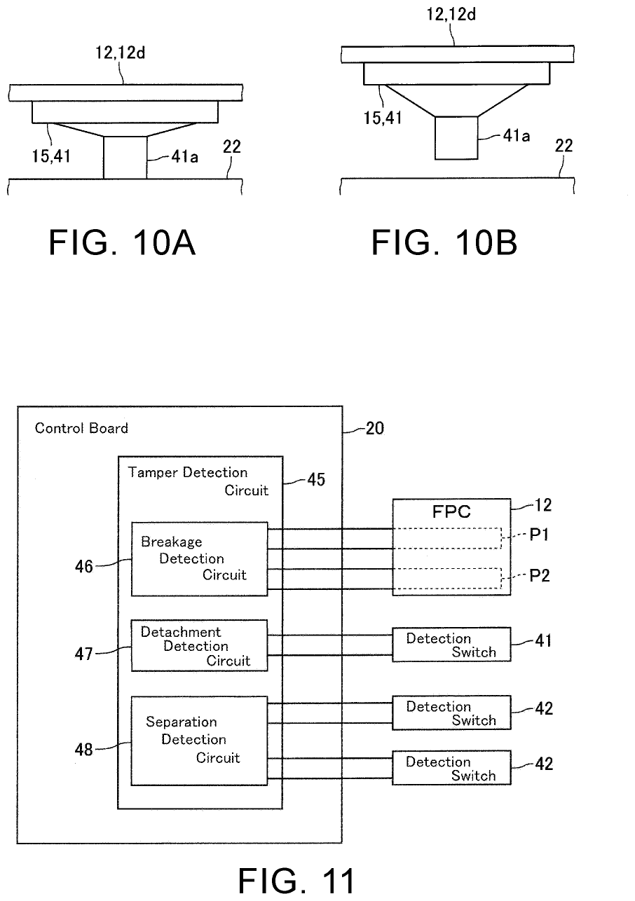

FIGS. 9A and 9B are perspective views showing the circuit board 11, the FPC 12 and the like shown in FIG. 5. FIGS. 10A and 10B are enlarged views showing a structure of the detachment detection mechanism 15 shown in FIG. 4.

As described above, the input module 4 includes the finger tip detection mechanism 3, the circuit board 11, the FPC 12, the cover member 13, the flat plate member 14 and the detachment detection mechanism 15. The circuit board 11 is, as described above, formed in a flat plate shape. The circuit board 11 is disposed in a slightly inclined state toward a lower side as going to a front side, and a thickness direction of the circuit board 11 is roughly coincided with the upper and lower direction.

In the following descriptions, one side in the thickness direction of the circuit board 11 is referred to as a first direction side, and an opposite side to the first direction side is referred to as a second direction side. In this embodiment, the first direction side is roughly coincided with a lower side and the second direction side is roughly coincided with an upper side. As described above, the input module 4 is fixed to an upper end part of the main body part 5, and the main body part 5 is disposed on a lower side of the input module 4. In other words, the main body part 5 is disposed on the one side (specifically, first direction side) with respect to the circuit board 11 in the thickness direction of the circuit board 11.

The finger tip detection mechanism 3 detects a position of a finger tip of a user in the input part 2. The finger tip detection mechanism 3 is structured of a first detection mechanism 31 and a second detection mechanism 32. The first detection mechanism 31 is a transmission type optical sensor having a light emitting part 33 and a light receiving part 34 which are oppositely disposed so as to interpose the aerial image display region “R” therebetween in the right and left direction. The second detection mechanism 32 is a transmission type optical sensor having a light emitting part 35 and a light receiving part 36 which are oppositely disposed so as to interpose the aerial image display region “R” therebetween in the front and rear direction. Each of the first detection mechanism 31 and the second detection mechanism 32 is an infrared sensor. Further, each of the first detection mechanism 31 and the second detection mechanism 32 is a line sensor. In each of the light emitting parts 33 and 35, a plurality of light emitting elements is arranged in a straight-line shape and, in each of the light receiving parts 34 and 36, a plurality of light receiving elements is arranged in a straight line shape.

The finger tip detection mechanism 3 is mounted on an upper side face of the circuit board 11. In other words, the finger tip detection mechanism 3 is mounted on a face on the second direction side of the circuit board 11. The finger tip detection mechanism 3 and the circuit board 11 are disposed on a lower side of the base part 13a of the cover member 13. Further, the finger tip detection mechanism 3 is disposed on an outer peripheral side with respect to the inner side tube part 13b of the cover member 13. In other words, the light emitting parts 33 and 35 and the light receiving parts 34 and 36 are disposed on an outer peripheral side with respect to the inner side tube part 13b. In this embodiment, the cover member 13 is formed of resin material which transmits infrared rays and infrared lights emitted from the light emitting parts 33 and 35 are transmitted through the inner side tube part 13b.

When a finger tip of a user is put in a predetermined area including the aerial image display region “R” (in other words, a predetermined area including the input part 2), an infrared light is not incident on specific light receiving elements of a plurality of the light receiving elements which are provided in the light receiving parts 34 and 36. Therefore, a position of a finger tip of a user is detected by the finger tip detection mechanism 3 in a predetermined area including the aerial image display region “R”. In this embodiment, a position of a finger tip of a user is detected by the finger tip detection mechanism 3 in the entire region of the aerial image display region “R” (in other words, in the entire region of the input part 2). A personal identification number which is inputted in the input part 2 is identified based on detection results of the finger tip detection mechanism 3.

The circuit board 11 and the flat plate member 14 are, as described above, formed in a rectangular frame shape. The circuit board 11 is disposed so that a direction of a long side of the circuit board 11 which is formed in a rectangular frame shape is substantially coincided with the front and rear direction, and the flat plate member 14 is disposed so that a direction of a long side of the flat plate member 14 which is formed in a rectangular frame shape is substantially coincided with the front and rear direction. The flat plate member 14 is formed in a frame shape which is substantially the same shape as the circuit board 11.

The flat plate member 14 is disposed so that a thickness direction of the flat plate member 14 and a thickness direction of the circuit board 11 are coincided with each other. Further, the flat plate member 14 is disposed on a lower side with respect to the circuit board 11 and is disposed between the circuit board 11 and the main body part 5 in a thickness direction of the circuit board 11. The flat plate member 14 covers the circuit board 11 from a lower side. The flat plate member 14 is fixed to the base part 13a of the cover member 13. In this embodiment, the flat plate member 14 is fixed to the base part 13a and thereby, the circuit board 11 is fixed to the cover member 13.

A front side part 11a which structures a front side portion of the circuit board 11 is mounted with an encryption circuit for processing and encrypting position data of a finger tip (specifically, output signals of the light receiving parts 34 and 36) which are detected by the finger tip detection mechanism 3. The front side part 11a is a portion of the circuit board 11 where processing of data required to ensure safety (security) is performed. The front side part 11a is connected with one end of a flexible printed board 39 (hereinafter, referred to as an “FPC 39”). The other end of the FPC 39 is connected with the control board 20. Encrypted data are transmitted from the circuit board 11 to the control board 20 through the FPC 39.

The FPC 12 is formed by bending a flat film-shaped flexible printed board having flexibility in a predetermined shape. The FPC 12 is electrically connected with the circuit board 11. Further, the FPC 12 is electrically connected with the control board 20 through the circuit board 11 and the FPC 39. The FPC 12 covers the front side part 11a of the circuit board 11. Further, the FPC 12 covers the front side part 11a from both sides in the thickness direction of the circuit board 11. In other words, the FPC 12 covers a part of the circuit board 11 from both sides in the thickness direction of the circuit board 11.

The FPC 12 is provided with a first board part 12a which covers the front side part 11a from the first direction side, a second board part 12b which covers the front side part 11a from the second direction side, and a connecting board part 12c which connects the first board part 12a with the second board part 12b. The first board part 12a is disposed on a lower side of the front side part 11a. The second board part 12b is disposed on an upper side of the front side part Ila. The connecting board part 12c is disposed on a front side with respect to the front side part 11a .

A width in the right and left direction of the first board part 12a and a width in the right and left direction of the second board part 12b are equal to each other. The connecting board part 12c connects a front end of the first board part 12a with a front end of the second board part 12b. The first board part 12a is disposed on an upper side of the front side part 14a which structures a front side portion of the flat plate member 14. The first board part 12a is stuck on an upper face of the front side part 14a (see FIG. 5). In other words, a part of the FPC 12 is stuck on the flat plate member 14.

Further, the FPC 12 is provided with a third board part 12d which is connected with the first board part 12a. A width in the right and left direction of the third board part 12d is narrower than a width in the right and left direction of the first board part 12a. The third board part 12d is disposed on a lower side with respect to the first board part 12a. The third board part 12d is connected with a front end of the first board part 12a. Further, the third board part 12d is disposed on a lower side of the front side part 14a of the flat plate member 14. The third board part 12d is stuck on a lower face of the front side part 14a.

A face on the first direction side of the first board part 12a and a face on the second direction side of the third board part 12d are faced each other through the front side part 14a.

As described above, the main body part 5 is disposed on a lower side with respect to the input module 4 and is disposed on a lower side with respect to the FPC 12. In other words, the main body part 5 is disposed on the first direction side with respect to the FPC 12. In this embodiment, the FPC 12 is disposed on an upper side of the housing 22 of the control module 21 and is overlapped with the control module 21 in the thickness direction of the circuit board 11. Specifically, the entire FPC 12 is overlapped with the housing 22 in the thickness direction of the circuit board 11. In other words, the entire portion of the circuit board 11 which is covered by the FPC 12 is overlapped with the housing 22 in the thickness direction of the circuit board 11.

The FPC 12 is formed with tamper detection patterns P1 and P2 (see FIG. 11). For example, the FPC 12 is formed with two tamper detection patterns P1 and P2. The tamper detection patterns P1 and P2 are provided for detecting own disconnections of the tamper detection patterns P1 and P2 and a short-circuit of the tamper detection patterns P1 with the tamper detection pattern P2. The tamper detection pattern P1 and the tamper detection pattern P2 are irregularly routed in a paired state. Further, the tamper detection patterns P1 and P2 are routed over the entire region of the FPC 12 and they are formed in the entire region of the FPC 12.

The detachment detection mechanism 15 includes a contact type detection switch 41. The detachment detection mechanism 15 in this embodiment is structured of the detection switch 41. The detection switch 41 is a push button switch. In other words, the detection switch 41 is a push type detection switch. The detection switch 41 is mounted on the FPC 12. Specifically, the detection switch 41 is mounted on a face on the first direction side (lower side face) of the third board part 12d. The detection switch 41 is electrically connected with the control board 20 through the FPC 12, the circuit board 11 and the FPC 39.

The detection switch 41 includes a movable pin 41a in a columnar shape which is movable in the thickness direction of the circuit board 11. The movable pin 41a is disposed so that an axial direction of the movable pin 41a and the thickness direction of the circuit board 11 are coincided with each other. The movable pin 41a is protruded toward the first direction side (lower side). The movable pin 41a is urged toward the first direction side. The detection switch 41 mounted on a face on the first direction side of the third board part 12d is disposed between a portion of the circuit board 11 (in other words, the front side part 11a) which is covered by the FPC 12 and the housing 22. In other words, the detection switch 41 is disposed between the portion of the circuit board 11 which is covered by the FPC 12 and the main body part 5.

When the input module 4 is fixed to the main body part 5 (in other words, when the circuit board 11 is attached to the main body part 5), a tip end face of the movable pin 41a is contacted with an upper end face of the housing 22. In this case, as shown in FIG. 10A, the movable pin 41a is pushed to an upper side by the housing 22 and thus, the detection switch 41 is set in an “ON” state. On the other hand, when the input module 4 is detached from the main body part 5, as shown in FIG. 10B, the movable pin 41a is moved to a lower side with respect to the third board part 12d and the detection switch 41 is turned to an “OFF” state.

Therefore, it is capable of detecting that the input module 4 has been detached from the main body part 5 (in other words, the circuit board 11 has been detached from the main body part 5) based on a detection result of the detection switch 41. In accordance with an embodiment of the present invention, it may be structured that the detection switch 41 is turned to an “OFF” state when the movable pin 41a is pushed to an upper side, and the detection switch 41 is turned to an “ON” state when the movable pin 41a is moved to a lower side.

Further, the second board part 12b is mounted with a contact type detection switch 42 for detecting that the first board part 12a and the second board part 12b are separated from each other (see FIG. 5). In other words, the input module 4 includes a contact type detection switch 42 structured to detect that the first board part 12a and the second board part 12b are separated from each other. The detection switch 42 is a push button switch which is similarly structured to the detection switch 41. The detection switch 42 in this embodiment is a second detection switch.

The detection switch 42 is mounted on a face on the first direction side (face on a lower side) of the second board part 12b. The detection switch 42 is mounted at two positions of the second board part 12b on both end sides in the right and left direction. The detection switch 42 is electrically connected with the control board 20 through the FPC 12, the circuit board 11 and the FPC 39. The detection switch 42 includes a movable pin 42a in a columnar shape which is movable in the thickness direction of the circuit board 11. The movable pin 42a is disposed so that an axial direction of the movable pin 42a and the thickness direction of the circuit board 11 are coincided with each other. The movable pin 42a is protruded toward the first direction side (lower side). The movable pin 42a is urged toward the first direction side.

When the flat plate member 14 is fixed to the cover member 13 and, in a state that the first board part 12a and the second board part 12b are approached each other, a tip end face of the movable pin 42a is contacted with a face on the second direction side of the first board part 12a. In this case, the movable pin 42a is pushed to an upper side by the first board part 12a and the flat plate member 14 and thus, the detection switch 42 is set in an “ON” state. On the other hand, when the flat plate member 14 is detached from the cover member 13 and the first board part 12a and the second board part 12b are separated from each other, the movable pin 42a is moved to a lower side with respect to the second board part 12b and thus, the detection switch 42 is turned to an “OFF” state.

Therefore, based on a detection result of the detection switch 42, it is capable of detecting that the first board part 12a and the second board part 12b are separated from each other. In accordance with an embodiment of the present invention, it may be structured that the detection switch 42 is set in an “OFF” state when the movable pin 42a is pushed to an upper side and, when the movable pin 42a is moved to a lower side, the detection switch 42 is set in an “ON” state.

(Configuration of Control Board)

FIG. 11 is an explanatory block diagram showing a configuration of the control board 20 in

FIG. 3.

The control board 20 is mounted with the tamper detection circuit 45 which is electrically connected with the FPC 12 and the detection switches 41 and 42. The tamper detection circuit 45 includes a breakage detection circuit 46 for detecting own disconnections of the tamper detection patterns P1 and P2 and a short circuit of the tamper detection pattern P1 with the tamper detection pattern P2, a detachment detection circuit 47 for detecting that the circuit board 11 is detached from the main body part 5, and a separation detection circuit 48 for detecting that the first board part 12a and the second board part 12b are separated from each other. The breakage detection circuit 46t is electrically connected with the tamper detection patterns P1 and P2. The detachment detection circuit 47 is electrically connected with the detection switch 41. The separation detection circuit 48 is electrically connected with two detection switches 42.

According to the input device 1 described above, in a case that a criminal is going to perform a fraudulent act for illegally acquiring data from the circuit board 11, when at least one of the following matters is detected in the tamper detection circuit 45, i.e., one of own disconnections of the tamper detection patterns P1 and P2, a short circuit of the tamper detection pattern P1 with the tamper detection pattern P2, detachment of the circuit board 11 from the main body part 5, and separation of the first board part 12a from the second board part 12b is detected, a predetermined abnormality processing is executed.

(Principal Effects in this Embodiment)

As described above, in this embodiment, the FPC 12 which is formed with the tamper detection patterns P1 and P2 covers the front side part 11a of the circuit board 11 which is a portion where processing of data required to ensure safety is performed. Therefore, according to this embodiment, when a criminal has illegally accessed the front side part 11a of the circuit board 11 for illegally acquiring data from the circuit board 11, the tamper detection patterns P1 and P2 are disconnected or short-circuited with each other. Further, in this embodiment, when a disconnection of at least one of the tamper detection patterns P1 and P2 is detected, a predetermined abnormality processing is executed.

Further, in this embodiment, the detachment detection mechanism 15 is provided for detecting that the circuit board 11 is detached from the main body part 5 and thus, when a criminal has detached the circuit board 11 from the main body part 5 for illegally acquiring data from the circuit board 11, it can be detected that the circuit board 11 has been detached from the main body part 5. Further, in this embodiment, when it is detected that the circuit board 11 is detached from the main body part 5, a predetermined abnormality processing is executed.

In addition, in this embodiment, the contact type detection switch 41 is disposed between a portion of the circuit board 11 (in other words, the front side part 11a) which is covered by the FPC 12 and the housing 22, and the housing 22 is disposed in the vicinity of the front side part 11a which is a portion of the circuit board 11 where processing of data required to ensure safety is performed. Therefore, according to this embodiment, it is difficult for a criminal to access the front side part 11a of the circuit board 11 which is a portion required to ensure safety.

As described above, in this embodiment, a predetermined abnormality processing is executed when a disconnection of at least one of the tamper detection patterns P1 and P2 is detected and, further, a predetermined abnormality processing is executed when it is detected that the circuit board 11 is detached from the main body part 5 and, in addition, it is difficult for a criminal to access a portion of the circuit board 11 which is required to ensure safety. Therefore, according to this embodiment, illegal acquisition of data from the circuit board 11 can be prevented effectively.

In this embodiment, the contact type detection switch 41 is disposed between a portion of the circuit board 11 (in other words, the front side part 11a) which is covered by the FPC 12 and the housing 22 of the control module 21, and the housing 22 of the control module 21 is disposed in the vicinity of the front side part 11a. Therefore, according to this embodiment, when a criminal illegally accesses the front side part 11a, the control module 21 may be easily damaged. Therefore, in this embodiment, a predetermined abnormality processing is executed when damage of the control module 21 is detected and thus, illegal acquisition of data from the circuit board 11 can be further effectively prevented.

In this embodiment, the entire front side part 11a of the circuit board 11 is overlapped with the housing 22 in a thickness direction of the circuit board 11. Therefore, according to this embodiment, it is further difficult for a criminal to access the front side part 11a. Further, when a criminal has illegally accessed the front side part 11a, the control module 21 may be further easily damaged. Therefore, when a predetermined abnormality processing is executed in a case that damage of the control module 21 is detected, illegal acquisition of data from the circuit board 11 can be further effectively prevented.

In this embodiment, the detection switch 41 is mounted on the FPC 12. Therefore, according to this embodiment, a board for mounting the detection switch 41 is not required to provide separately.

Accordingly, in this embodiment, structure of the input device 1 can be simplified. Further, in this embodiment, the circuit board 11 is covered by the flat plate member 14 from a lower side and thus, it is further difficult for a criminal to access the front side part 11a of the circuit board 11.

In this embodiment, the FPC 12 is mounted with the contact type detection switch 42 for detecting separation of the first board part 12a from the second board part 12b and, when separation of the first board part 12a from the second board part 12b is detected, a predetermined abnormality processing is executed. Therefore, according to this embodiment, if a criminal has performed some act for illegally acquiring data from the circuit board 11 and, when the first board part 12a and the second board part 12b are separated from each other, a predetermined abnormality processing is executed. Accordingly, in this embodiment, illegal acquisition of data from the circuit board 11 can be further effectively prevented.

In this embodiment, the detection switch 41 is mounted on a face on the first direction side of the third board part 12d and the detection switch 42 is mounted on a face on the first direction side of the second board part 12b and, in the FPC 12 in a developed state (in other words, in the FPC 12 before it is bent in a predetermined shape), the detection switch 41 and the detection switch 42 are mounted on the same face of the FPC 12. Therefore, according to this embodiment, mounting work of the detection switches 41 and 42 on the FPC 12 can be performed easily.

### OTHER EMBODIMENTS

Although the present invention has been shown and described with reference to a specific embodiment, various changes and modifications will be apparent to those skilled in the art from the teachings herein.

In the embodiment described above, the main body part 5 includes the aerial image display mechanism 18. However, it may be structured that the main body part 5 does not include the aerial image display mechanism 18. In this case, for example, a display mechanism such as a liquid crystal display is disposed on a lower side with respect to the inner side tube part 13b of the cover member 13. Also in this case, an inner peripheral side with respect to the inner side tube part 13b is the input part 2. A user inputs his/her personal identification number by utilizing a keypad displayed by the display mechanism. Specifically, a user successively moves his/her finger tip on an upper side of a predetermined key in a keypad displayed by the display mechanism to input his/her personal identification number without touching the display mechanism.

In the embodiment described above, the first detection mechanism 31 and the second detection mechanism 32 may be structured of a reflection type optical sensor which is provided with a light emitting part which emits an infrared light and a light receiving part on which the infrared light emitted from the light emitting part and reflected by a finger tip of a user is incident. Further, in the embodiment described above, the finger tip detection mechanism 3 may be a sensor other than an optical type sensor. For example, the finger tip detection mechanism 3 may be an electrostatic capacitance sensor.

In the embodiment described above, the detection switch 41 is provided with the movable pin 41a. However, the detection switch 41 may be a membrane switch (sheet switch) which is not provided with the movable pin 41a. Further, the detection switch 41 may be a lever type detection switch. Similarly, the detection switch 42 may be a membrane switch or a lever type detection switch. Further, in the embodiment described above, it may be structured that the input module 4 does not include the detection switch 42.

In the embodiment described above, the number of the tamper detection patterns formed in the FPC 12 may be one or three or more. In a case that the number of a tamper detection pattern formed in the FPC 12 is one, the tamper detection pattern is provided for detecting its own disconnection. Further, in the embodiment described above, the FPC 12 may be provided with no third board part 12d. In this case, the detection switch 41 is mounted on a face on the first direction side (face on a lower side) of the first board part 12a. In addition, in the embodiment described above, it may be structured that the detection switch 41 is not mounted on the FPC 12. In this case, a board on which the detection switch 41 is mounted is provided separately.

In the embodiment described above, it may be structured that only a part of the front side part 11a of the circuit board 11 is overlapped with the housing 22 in a thickness direction of the circuit board 11. Further, in the embodiment described above, the entire or a part of the front side part 11a may be overlapped with the housing 19 in a thickness direction of the circuit board 11. Further, in the embodiment described above, information inputted in the input part 2 may be information other than a personal identification number. For example, a signature of a user may be inputted in the input part 2. In addition, in the embodiment described above, the circuit board 11 may be a flexible printed board. Further, the input device 1 to which the present invention is applied may be used as a device other than an authentication device.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An input device in which information is inputted by using a finger tip of a user, the input device comprising:
a finger tip detection mechanism which detects a position of the finger tip of the user in an input part to which information is inputted;
a circuit board on which the finger tip detection mechanism is mounted;
a flexible printed board which covers at least a part of the circuit board;
a main body part to which the circuit board is attached; and
a detachment detection mechanism which detects detachment of the circuit board from the main body part;
wherein the flexible printed board is formed with a tamper detection pattern for detecting at least own disconnection;
the detachment detection mechanism comprises a contact type detection switch; and
the contact type detection switch is disposed between a portion of the circuit board which is covered by the flexible printed board and the main body part.

2. The input device according to claim 1, wherein
the main body part comprises a control module having a control board which is electrically connected with the circuit board,
encrypted data are transmitted to the control board from the circuit board,
the control module comprises a housing in which the control board is accommodated, and
the contact type detection switch is disposed between a portion of the circuit board which is covered by the flexible printed board and the housing.

3. The input device according to claim 2, wherein
the flexible printed board covers the part of the circuit board from both sides in a thickness direction of the circuit board,
the main body part is disposed on one side with respect to the circuit board in the thickness direction of the circuit board, and
an entire portion of the circuit board which is covered by the flexible printed board is overlapped with the housing in the thickness direction of the circuit board.

4. The input device according to claim 1, wherein the contact type detection switch is mounted on the flexible printed board.

5. The input device according to claim 1, further comprising a flat plate member in a flat plate shape which is disposed between the circuit board and the main body part in a thickness direction of the circuit board,
wherein a part of the flexible printed board is stuck on the flat plate member.

6. The input device according to claim 1, wherein in response to one side in a thickness direction of the circuit board being referred to as a first direction side, and an opposite side to the first direction side being referred to as a second direction side,
the flexible printed board comprises:
a first board part which covers the part of the circuit board from the first direction side;
a second board part which covers the part of the circuit board from the second direction side; and
a connecting board part which connects the first board part with the second board part, and the main body part is disposed on the first direction side with respect to the flexible printed board.

7. The input device according to claim 6, further comprising a contact type second detection switch which detects separation of the first board part from the second board part.

8. The input device according to claim 7, wherein
the flexible printed board comprises a third board part which is connected with the first board part,
a face on the first direction side of the first board part and a face on the second direction side of the third board part are faced each other,
the contact type second detection switch is mounted on a face on the first direction side of the second board part, and
the contact type detection switch is mounted on a face on the first direction side of the third board part.

9. The input device according to claim 1, wherein
the main body part comprises:
a display mechanism comprising a display surface which displays an image; and
an aerial image forming mechanism which forms an image as an aerial image by projecting the image displayed on the display surface in a space, and
the input part is an aerial image display region which is a region where the aerial image is displayed.

10. The input device according to claim 3, wherein the contact type detection switch is mounted on the flexible printed board.

11. The input device according to claim 10, further comprising a flat plate member in a flat plate shape which is disposed between the circuit board and the main body part in the thickness direction of the circuit board,
wherein a part of the flexible printed board is stuck on the flat plate member.

12. The input device according to claim 11, wherein in response to one side in the thickness direction of the circuit board being referred to as a first direction side, and an opposite side to the first direction side being referred to as a second direction side,
the flexible printed board comprises:
a first board part which covers the part of the circuit board from the first direction side;
a second board part which covers the part of the circuit board from the second direction side; and
a connecting board part which connects the first board part with the second board part, and
the main body part is disposed on the first direction side with respect to the flexible printed board.

13. The input device according to claim 12, further comprising a contact type second detection switch which detects separation of the first board part from the second board part.

14. The input device according to claim 13, wherein
the flexible printed board comprises a third board part which is connected with the first board part,
a face on the first direction side of the first board part and a face on the second direction side of the third board part are faced each other,
the contact type second detection switch is mounted on a face on the first direction side of the second board part, and
the contact type detection switch is mounted on a face on the first direction side of the third board part.

15. The input device according to claim 14, wherein
the main body part comprises:
a display mechanism comprising a display surface which displays an image; and
an aerial image forming mechanism which forms an image as an aerial image by projecting an image displayed on the display surface in a space, and
the input part is an aerial image display region which is a region where the aerial image is displayed.
